(19) United States
(12) Patent Application Publication
(10) Pub. No.: US 2014/0047697 A1
(43) Pub. Date: Feb. 20, 2014

(54) ELASTIC TUBE ALIGNMENT SYSTEM AND METHOD FOR PRECISELY LOCATING MULTIPLE COMPONENTS

(71) Applicant: GM GLOBAL TECHNOLOGY OPERATIONS LLC, DETROIT, MI (US)

(72) Inventor: Steven E. Morris, Fair Haven, MI (US)

(73) Assignee: GM GLOBAL TECHNOLOGY OPERATIONS LLC, DETROIT, MI (US)

(21) Appl. No.: 13/960,124

(22) Filed: Aug. 6, 2013

Related U.S. Application Data
(60) Provisional application No. 61/683,136, filed on Aug. 14, 2012.

(51) Int. Cl. B25B 27/14

(52) U.S. Cl. CPC B25B 27/14
USPC 29/466; 29/283.5

(57) ABSTRACT

An alignment system includes first, second and third components. A plurality of upstanding elastic tubes, each having a tube wall, extending from the first component. A plurality of apertures, each having an aperture wall, is formed in the second component and the third component, the plurality of apertures are geometrically distributed in coordinated relationship to a geometrical distribution of the plurality of elastic tubes such that each elastic tube is receivable into a respective aperture. When each elastic tube is received into its respective aperture an elastic deformation occurs at an interface between the tube wall and the aperture wall. The elastic deformation is responsive to each tube wall having a diameter larger than a cross-section of its respective aperture. The elastic deformation is elastic averaged over the plurality of elastic tubes such that the first component is precisely located relative to the second component and the third component.

### CROSS REFERENCE TO RELATED APPLICATIONS

This application claims the benefit of U.S. Provisional Application Ser. No. 61/683,136, filed Aug. 14, 2012, which is incorporated herein by reference in its entirety.

### FIELD OF THE INVENTION

The subject invention relates to location features for aligning at least three components during a mating operation. More particularly, the subject invention relates to a plurality of mutually spaced apart elastic tube alignment features of a first component which elastically deform on average when mated to receiving aperture alignment features of a second component and at least a third component to thereby precisely align the first and second and at least third components during a mating operation.

### BACKGROUND

Currently, components, particularly vehicular components such as those found in automotive vehicles, which are to be mated together in a manufacturing process are mutually located with respect to each other by alignment features that are oversized and/or undersized to provide spacing to freely move the components relative to one another to align them without creating an interference therebetween that would hinder the manufacturing process. One example includes two-way and/or four-way male alignment features, typically upstanding bosses, which are received into corresponding female alignment features, typically apertures in the form of holes or slots. There is a clearance between the male alignment features and their respective female alignment features which is predetermined to match anticipated size and positional variation tolerances of the male and female alignment features as a result of manufacturing (or fabrication) variances. As a result, significant positional variation can occur between the mated first and second components having the aforementioned alignment features, which may contribute to the presence of undesirably large variation in their alignment, particularly with regard to the gaps and spacing between them. In the case where these misaligned components are also part of another assembly, such misalignments can also affect the function and/or aesthetic appearance of the entire assembly. Regardless of whether such misalignment is limited to two components or an entire assembly, it can negatively affect function and result in a perception of poor quality.

When more than two or more components are to be mated together, the positional variation as between the mated first, second, third and any subsequent layers is further exacerbated by the potential for positional variation between each component in relation to the other components, which further contributes to the presence of undesirably large variations, resulting in non-uniform gaps between the respective components and otherwise poor fit therebetween.

Accordingly, the art of alignment systems can be enhanced by providing an improved alignment system or mechanism that can ensure precise alignment of three or more components via elastic averaging.

### SUMMARY OF THE INVENTION

In one exemplary embodiment, an elastic tube alignment system for aligning components to one another is disclosed. The system includes a first component, a second component and a third component. The system also includes a plurality of upstanding elastic tubes extending from the first component, each elastic tube having a tube wall. The system further includes a plurality of apertures formed in the second component and the third component, each aperture having an aperture wall, the plurality of apertures geometrically distributed in coordinated relationship to a geometrical distribution of the plurality of elastic tubes such that each elastic tube is receivable into a respective aperture, wherein when each elastic tube is received into its respective aperture an elastic deformation occurs at an interface between the tube wall and the aperture wall, wherein the elastic deformation is responsive to each tube wall having a diameter larger than a cross-section of its respective aperture, and wherein the elastic deformation is elastic averaged over the plurality of elastic tubes such that the first component is precisely located relative to the second component and the third component.

In another exemplary embodiment, a method for precisely aligning components of a motor vehicle during a mating operation is disclosed. The method includes providing a first vehicle component, the first vehicle component comprising a plurality of upstanding elastic tubes extending from the first vehicle component, each elastic tube having a tube wall. The method also includes providing a second vehicle component and providing a third vehicle component, the second vehicle component and the third vehicle component each having a plurality of apertures formed therein, each aperture having an aperture wall, the plurality of apertures of the second vehicle component and the third vehicle component geometrically distributed in a coordinated relationship to a geometrical distribution of the plurality of elastic tubes such that each elastic tube is receivable into a respective aperture. The method further includes mating the first vehicle component to the second vehicle component, wherein during mating the first vehicle component is aligned to the second vehicle component and the third vehicle component by each elastic tube being received into its respective aperture. Still further, the method includes elastically deforming an interface between each elastic tube and its respective aperture in the second vehicle component and the third vehicle component. Finally, the method includes performing an elastic averaging of the elastic deformation over the plurality of elastic tubes such that upon mating, a precise location of the first vehicle component to the second vehicle and the third vehicle component is realized.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a schematic top plan view of an embodiment of an alignment system and assembly in accordance with an embodiment of the invention disclosed herein;

FIG. 2 is a cross-sectional view of FIG. 1 taken along Section 2-2;

FIG. 3 is a cross-sectional view of FIG. 1 taken along Section 3-3;

FIG. 4 is a cross-sectional view of an embodiment of an elastic tube and a plurality of apertures in accordance with an embodiment of the invention disclosed herein;

FIG. 5 is a cross-sectional view similar to that of FIG. 2, but with a different arrangement of assembly components, in accordance with an embodiment of the invention disclosed herein;

FIG. 6 is a flowchart of a method of aligning an assembly of components in accordance with an embodiment of the invention disclosed herein; and

FIG. 7 is a schematic top plan view similar to that of FIG. 1 of another embodiment of an alignment system and assembly in accordance with an embodiment of the invention disclosed herein.

### DESCRIPTION OF THE EMBODIMENTS

The following description is merely exemplary in nature and is not intended to limit the present disclosure, its application or uses. For example, the embodiments shown comprise vehicle components but the alignment system may be used with any suitable components to provide elastic averaging for precision location and alignment of all manner of mating components and component applications, including many industrial, consumer product (e.g., consumer electronics, various appliances and the like), transportation, energy and aerospace applications, and particularly including many other types of vehicular components and applications, such as various interior, exterior and under hood vehicular components and applications. It should be understood that throughout the drawings, corresponding reference numerals indicate like or corresponding parts and features.

As used herein, the term “elastically deformable” refers to components, or portions of components, including component features, comprising materials having a generally elastic deformation characteristic, wherein the material is configured to undergo a resiliently reversible change in its shape, size, or both, in response to application of a force. The force causing the resiliently reversible or elastic deformation of the material may include a tensile, compressive, shear, bending or torsional force, or various combinations of these forces. The elastically deformable materials may exhibit linear elastic deformation, for example that described according to Hooke's law, or non-linear elastic deformation.

Elastic averaging provides elastic deformation of the interface(s) between mated components, wherein the average deformation provides a precise alignment, the manufacturing positional variance being minimized to Xₘᵢₙ, defined by Xₘᵢₙ=X/√N, wherein X is the manufacturing positional variance of the locating features of the mated components and N is the number of features inserted. To obtain elastic averaging, an elastically deformable component is configured to have at least one feature and its contact surface(s) that is over-constrained and provides an interference fit with a mating feature of another component and its contact surface(s). The over-constrained condition and interference fit resiliently reversibly (elastically) deforms at least one of the at least one feature or the mating feature, or both features. The resiliently reversible nature of these features of the components allows repeatable insertion and withdrawal of the components that facilitates their assembly and disassembly. Positional variance of the components may result in varying forces being applied over regions of the contact surfaces that are over-constrained and engaged during insertion of the component in an interference condition. It is to be appreciated that a single inserted component may be elastically averaged with respect to a length of the perimeter of the component. The principles of elastic averaging are described in detail in commonly owned, co-pending U.S. patent application Ser. No. 13/187,675, the disclosure of which is incorporated by reference herein in its entirety. The embodiments disclosed above provide the ability to convert an existing component that is not compatible with the above-described elastic averaging principles, or that would be further aided with the inclusion of a four-way elastic averaging system as herein disclosed, to an assembly that does facilitate elastic averaging and the benefits associated therewith.

Any suitable elastically deformable material may be used for the mating components and alignment features disclosed herein and discussed further below, particularly those materials that are elastically deformable when formed into the features described herein. This includes various metals, polymers, ceramics, inorganic materials or glasses, or composites of any of the aforementioned materials, or any other combinations thereof suitable for a purpose disclosed herein. Many composite materials are envisioned, including various filled polymers, including glass, ceramic, metal and inorganic material filled polymers, particularly glass, metal, ceramic, inorganic or carbon fiber filled polymers. Any suitable filler morphology may be employed, including all shapes and sizes of particulates or fibers. More particularly any suitable type of fiber may be used, including continuous and discontinuous fibers, woven and unwoven cloths, felts or tows, or a combination thereof. Any suitable metal may be used, including various grades and alloys of steel, cast iron, aluminum, magnesium or titanium, or composites thereof, or any other combinations thereof. Polymers may include both thermoplastic polymers or thermoset polymers, or composites thereof, or any other combinations thereof, including a wide variety of co-polymers and polymer blends. In one embodiment, a preferred plastic material is one having elastic properties so as to deform elastically without fracture, as for example, a material comprising an acrylonitrile butadiene styrene (ABS) polymer, and more particularly a polycarbonate ABS polymer blend (PC/ABS). The material may be in any form and formed or manufactured by any suitable process, including stamped or formed metal, composite or other sheets, forgings, extruded parts, pressed parts, castings, or molded parts and the like, to include the deformable features described herein. The elastically deformable alignment features and associated component may be formed in any suitable manner. For example, the elastically deformable alignment features and the associated component may be integrally formed, or they may be formed entirely separately and subsequently attached together. When integrally formed, they may be formed as a single part from a plastic injection molding machine, for example. When formed separately, they may be formed from different materials to provide a predetermined elastic response characteristic, for example. The material, or materials, may be selected to provide a predetermined elastic response characteristic of any or all of the elastically deformable alignment features, the associated component, or the mating component. The predetermined elastic response characteristic may include, for example, a predetermined elastic modulus.

As used herein, the term vehicle is not limited to just an automobile, truck, van or sport utility vehicle, but includes any self-propelled or towed conveyance suitable for transporting a burden.

The subject invention is an elastic tube alignment system for the precise mating of three or more components, particularly motor vehicle components, wherein when mating is completed there is a lack of float (or play) as between the male and female alignment features so as to provide a precision alignment with stiffened positional constraint, yet the aligned mating proceeds smoothly and effortlessly each time.

The elastic tube alignment system according to an embodiment of the invention operates on the principle of elastic averaging. A plurality of geometrically separated elastic tube (male) alignment features are disposed on a first component, while a plurality of one-to-one corresponding aperture (female) alignment features are provided on at least two other components (e.g., a second component and a third component), wherein the elastic tube alignment features have a diameter exceeding a cross-section of the aperture alignment features. However, the first, second and third components may each have some of the elastic tube alignment features and some of the aperture alignment features so long as they one-to-one correspond so that they are mutually engageable with one another. During the mating of the first component to the second and third components, each elastic tube alignment feature respectively engages its corresponding aperture alignment feature. As the elastic tube alignment features are received into the respective aperture alignment features, any manufacturing variance in terms of position and size of the elastic tube and aperture alignment features is accommodated by elastic deformation, on average, at the interface between the elastic tube and aperture alignment features. This elastic averaging across the plurality of elastic tube and aperture alignment features provides a precise alignment as between the first, second, third and any subsequent components when they are mated relative to each other, and yet the mating proceeds smoothly and easily.

In accordance with an embodiment of the invention, the elastic averaging provides a precise alignment of the components where the manufacturing positional variance is minimized to Xₘᵢₙ. Thus, the needed clearance for the male and female alignment features of the prior art is obviated by an embodiment of the invention.

According to an embodiment of the invention, the elastic tube alignment features are elastically deformable by elastic compression of the tube wall of the elastic tube, which deformation is preferably resiliently reversible. In an embodiment of the invention, the elastic tube alignment features are connected (typically integrally) with a first component in upstanding, perpendicular relation to a predetermined surface of the first component. Further according to an embodiment of the invention, it is possible, but not required, for the respective aperture alignment members to be elastically deformable by elastic expansion of the aperture wall of the apertures, which deformation is preferably resiliently reversible. In an embodiment, the aperture alignment features are disposed at a second component and a third component, typically as a slot or a hole in predetermined surfaces of the second and third component, wherein the diameter of the elastic tube alignment features exceeds the cross-section of the aperture alignment features (i.e., a purposeful interference condition exists between the elastic tube alignment features and each associated aperture alignment feature), whereby elastic deformation occurs as each elastic tube alignment feature is received into its respective aperture alignment feature. The process of mating with precise alignment is both smoothly and easily performed. The mating may be enhanced by a tapering (smaller diameter with increasing height) of the elastic tube alignment features so as to facilitate their initial entry into the aperture alignment features, and/or by beveling of the aperture wall of the aperture alignment features so as to locally pronounce the elastic deformation at the interface of the aperture wall with the tube wall.

In operation, as the first, second and third and any additional (e.g. fourth, fifth, etc.) components are mated together, the initial contact therebetween is at the plurality of geometrically spaced apart elastic tube alignment members passing into their one-to-one corresponding aperture alignment features. Because of the larger size of the diameter of elastic tube alignment features relative to the cross-section of the aperture alignment features, an elastic deformation occurs at the interface therebetween, and this deformation is averaged over the geometrical distribution of the plurality of elastic tube alignment features. The alignment becomes precise when all of the first, second and third (and any additional) components have fully mated because the tapering, when employed, of the elastic tube alignment features provides a largest diameter to the cross-section of the aperture alignment features when these components have arrived at a final mating position. When an affixment modality is implemented, such as for example threaded fasteners, heat staking, sonic welding, push nuts, clips, etc., the precise alignment becomes manifest, and the visible joint between the two components is a Class A finish with predetermined gap and spacing requirements between the components having been established.

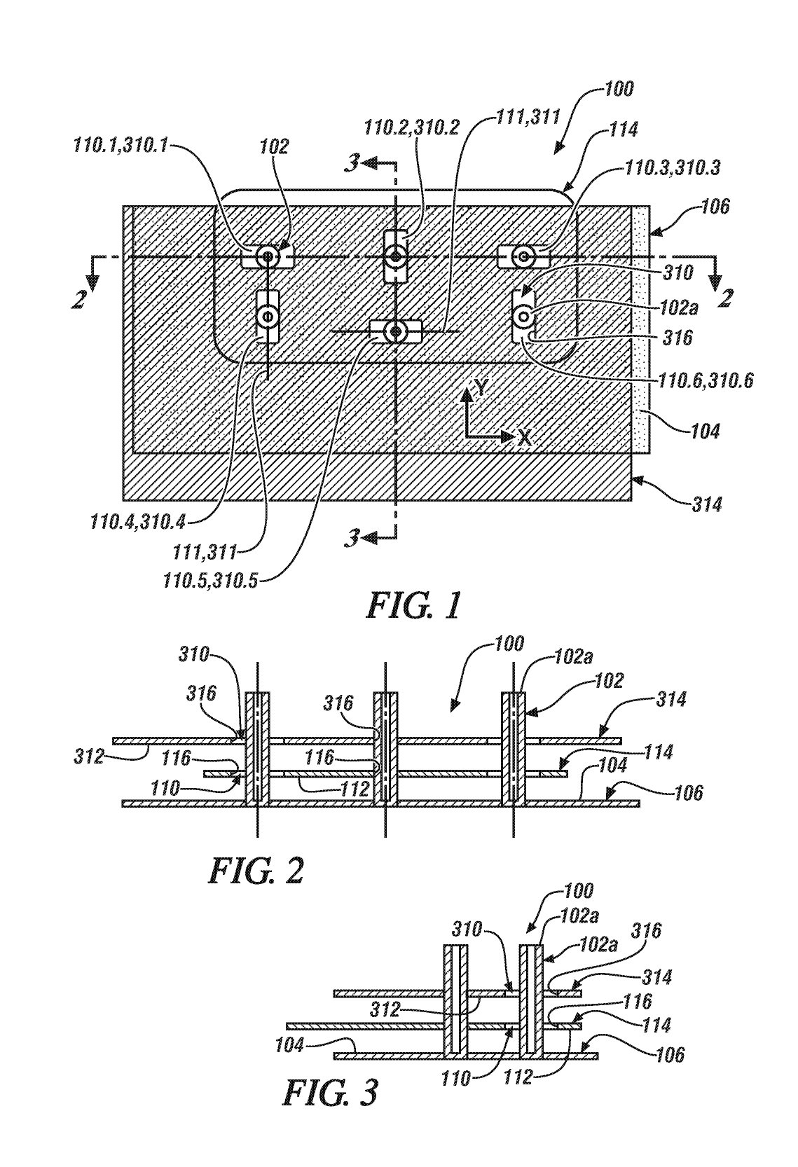

Reference is now made to FIGS. 1-4, which depict various examples of the structure and function of an elastic tube alignment system 100 as disclosed herein.

The elastic tube alignment system 100 operates on the principle of elastic averaging. A plurality of mutually separated elastic tube alignment features (serving as male alignment features) 102 (hereinafter referred to simply as “elastic tubes”) are disposed on a first surface 104 of a first component 106. As best shown in FIGS. 2-4, the elastic tubes 102 are upstanding in perpendicular relation to the first surface 104, wherein six mutually separated elastic tubes are on the surface of the first component 106 (best seen with reference to FIG. 1). Each of the elastic tubes 102 is tubular in shape, having a tube wall 102a. Preferably, the tube wall 102a defines a hollow cylinder. The tube wall 102a is elastic, being preferably stiffly elastic, wherein the shape is resiliently reversible in response to a compressive force being applied thereto. These elastic tubes 102 and corresponding apertures 110, 310 (discussed further below) and their use in and for alignment system are described in commonly owned, co-pending U.S. patent application Ser. No. 13/187,675.

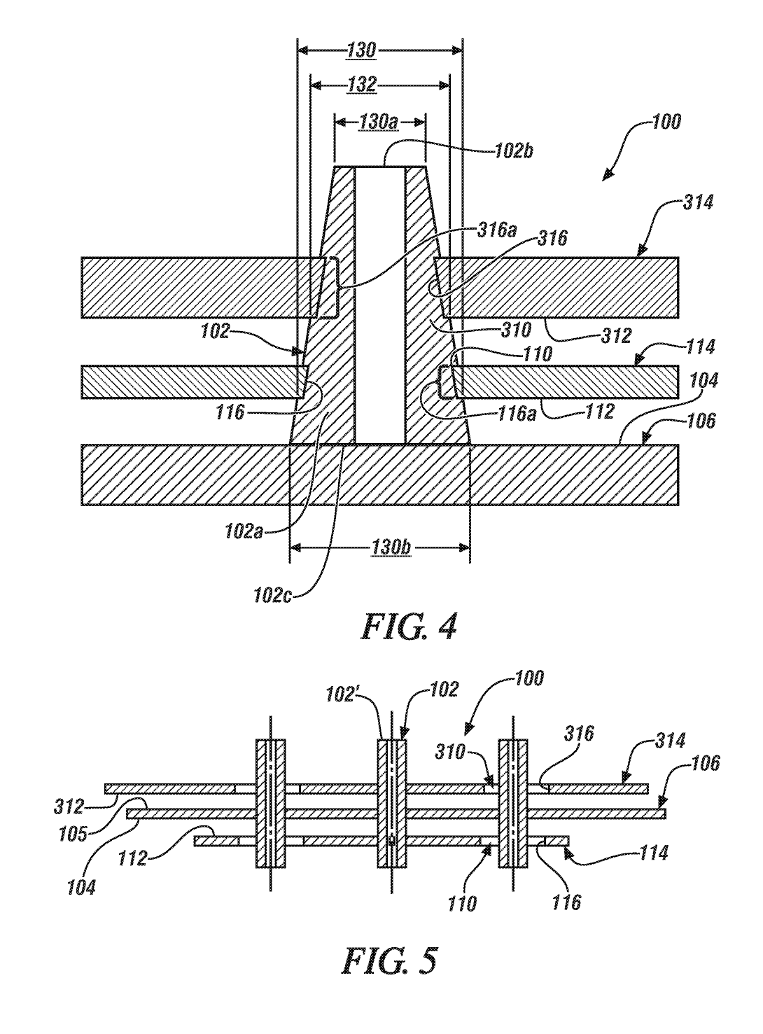

A plurality of aperture alignment features (serving as female alignment features) 110 (hereinafter referred to simply as “apertures”) are disposed in a second surface 112 of a second component 114, being located in one-to-one correspondence with the plurality of elastic tubes 102; that is, for each elastic tube is a respective aperture 110 into which it is receivable. Thus, the plurality of apertures 110 are geometrically distributed in coordinated relationship to a geometrical distribution of the plurality of elastic tubes 102 such that each elastic tube 102 is receivable into its respective aperture 110. While the apertures 110 are shown as elongated slots, it will be appreciated that the aperture shape could be otherwise, such as for example an elongated hole, a generally round hole, etc. Preferably, an aperture wall 116 which defines the opening demarcation of the aperture alignment features 110 is beveled 116a (best seen with reference to FIG. 4). A preferred material for the second component 114 in which the apertures 110 are disposed is one having elastic properties so as to elastically deform without fracture, as described herein.

A plurality of aperture alignment features (serving as female alignment features) 310 (hereinafter referred to simply as “apertures”) are disposed in a third surface 312 of a third component 314, being located in one-to-one correspondence with the plurality of elastic tubes 102 and apertures 110; that is, for each elastic tube 102 is a respective aperture 310 into which it is receivable. Thus, the plurality of apertures 310 are geometrically distributed in coordinated relationship to a geometrical distribution of the plurality of elastic tubes 102 such that each elastic tube 102 is receivable into its respective aperture 310. While the apertures 310 are shown as elongated slots, it will be appreciated that the aperture shape could be otherwise, such as for example an elongated hole, a generally round hole, etc. Preferably, an aperture wall 316 which defines the opening demarcation of the aperture alignment features 310 is beveled 316a (best seen with reference to FIG. 4). A preferred material for the third component 314 in which the apertures 310 are disposed is one having elastic properties so as to elastically deform without fracture, as described herein.

The apertures 110, 310 may have any suitable shape, including an elongated shape having a length greater than its width, such as a rectangle, rounded rectangle, or a rectangular shape having ends defined by outwardly extending, opposed curved (e.g. circular) arcs. In one embodiment, the elongated apertures 110, 310 may have a substantially uniform aperture width except in the end regions, which may be rounded or curved as described herein. The apertures 110, 310 of a given component may have the same size, or different sizes. In an embodiment, the apertures 110 of the second component 114 have a second aperture width (130) and the apertures 310 of the third component 314 have a third aperture width (132). In one embodiment, the second aperture width 130 and the third aperture width 132 of respective apertures (those that align over the same elastic tube) are different, and more particularly, the second aperture width 130 is larger than the third aperture width 132. Different aperture widths are particularly useful when the elastic tube 102 is tapered, and the second component 114 is proximate the first component 106, and the third component 314 is proximate the second component 114. In this way, the elastic deformation of the elastic tube 102 in the regions proximate the second component 114 and the third component 314 may be controlled, and more particularly the second aperture width 130 and third aperture width 132 may be selected to provide the same elastic deformation in these regions, or alternately, to provide relatively higher or lower elastic deformations in these regions.

The elongated apertures 110 of the second component 114 have second elongation axes (major axes) 111 and the elongated apertures of the third component 314 have third elongation axes (major axes) 311 along their length (i.e. the elongated dimension) (best seen with reference to FIG. 1). For respective apertures 110, 310, the apertures may be arranged so that the respective axes 111, 311 are parallel to one another or not parallel to one another. In one embodiment, a predetermined portion of the second elongation axes 111 are parallel to the third elongation axes 311 of respective apertures 110, 310. In another embodiment, a predetermined portion of the second elongation axes 111 are not parallel to the third elongation axes 311 of respective apertures 110, 310.

The first, second and third components 106, 114, 314 may include motor vehicle components, but this is not a requirement. The alignment system 100 may be employed with any suitable number of components, and is not limited to an application with only three components. While the embodiments herein are described using three components 106, 114, 314, more than three components can be aligned using the alignment system 100 described herein, including a fourth, fifth, sixth, etc. components, in any number.

As depicted schematically in FIG. 4, the diameter, 130b tapering down to 130a, of the elastic tubes 102 exceeds a cross-section 130, 132 of the respective apertures 110, 310, at the respective locations of engagement, whereby elastic deformation proceeds as each elastic tube 102 is received into its respective aperture 110, 310. As in FIG. 4, the elastic deformation of the tube wall 102a is locally pronounced due to the beveling 116a, 316a of the respective aperture wall 116, 316, wherein there is provided a relatively small contact area as between the respective aperture wall contact surface (herein referred to by reference numerals 116a, 316a) and the tube wall 102a. Since the compressive force between the aperture wall and the tube wall is limited to the smaller surface area of the aperture wall contact surface, a higher compressive pressure is provided.

The process of mating the first component 106 to the second component 114 and third component 314 is both smoothly and easily performed, facilitated by a tapering (smaller diameter with increasing height, as shown comparatively at FIG. 4 by distal and proximal diameters 130a and 130b of the distal and proximal ends 102b, 102c of the tube wall 102a. In this regard, the tapering of the elastic tubes 102 presents a largest diameter, ranging from 130b down to 130a, at the cross-section of the apertures 110, 310 when the first 106, second 114 and third 314 components have arrived at a final mating position, as depicted in FIG. 4; further, the tapering may present a smallest diameter 130a of the tube wall 102a at the distal end 102b so as to ease initial entry of the elastic tubes 102 into the apertures 110, 310.

During the mating of the first component 106 to the second component 114 and third component 314, each elastic tube 102 respectively engages its corresponding aperture 110, 310 wherein as the elastic tubes 102 pass into the apertures 110, 310, any manufacturing variance in terms of position and size thereof is accommodated by elastic deformation on average of the plurality of elastic tubes 102 and apertures 110, 310. This elastic averaging across the plurality of elastic tubes 102 and apertures 110, 310 provides a precise alignment as between the first, second and third components 106, 114, 314 when they are finally mated relative to each other.

According to an embodiment of the invention, the elastic averaging provides elastic deformation of the interface between the plurality of geometrically distributed elastic tube alignment features 102 and the aperture alignment features 110, 310 wherein the average deformation provides a precise alignment, the manufacturing variance being minimized to Xₘᵢₙ.

Further according to an embodiment of the invention, it is possible, but not required, for the aperture alignment members 110, 310 to be also elastically deformable by elastic expansion of the aperture sidewall, which deformation is also preferably reversible.

The assembly of the elastic tube alignment system 100 is now described. The first, second and third components 106, 114, 314 are brought into close proximity to each other with near alignment. As the first, second and third components 106, 114, 314 are mated together, with the second component 114 being disposed between the first and third components 106, 314, the initial contact therebetween is via the plurality of geometrically spaced apart elastic tubes 102 passing into their one-to-one corresponding apertures 110, 310 whereafter the first, second and third components 106, 114, 314 align to one another. The alignment is precise in FIGS. 1-3, wherein the first, second and third components 106, 114, 314 are depicted fully mated. The alignment is precise because of the largest size diameter of elastic tubes 102 relative to the cross-section of the respective apertures 110, 310 results in elastic deformation, and this elastic deformation is elastic averaged over the plurality of geometrically distributed elastic tubes 102. When an affixment modality is implemented, such as for example threaded fasteners, heat staking (e.g., by locally melting and deforming the tops of the tubes), sonic welding, etc., the precise alignment becomes manifest, and the visible joint between the two components is a Class A finish.

In FIG. 5, a second embodiment for implementing the elastic tube alignment system 100 according to an embodiment of the invention is depicted. In this example, the first component 106 has elastic tubes 102 that extend perpendicularly outward from the first surface 104 and from a second surface 105. The second component 114 has apertures 110 and is aligned to the first component 106 in the manner described above proximate the first surface 104. The third component 314 has apertures 310 and is aligned to the first component 106 in the manner described above proximate the second surface 105. The alignment of the second component 114 and the third component 314 may be performed at the same time or separately depending on the system 100 alignment requirements for the respective components.

As depicted in FIG. 5, the first, second and third components 106, 114, 314 have been aligned relative to each other by elastic average deformation of the elastic tube features 102 interfacing with the aperture alignment features 110, 310 according to the elastic tube alignment system 100 of the subject invention, whereby the first component 106, which is between the second component 114 and third component 314, is precisely aligned with respect to the second and third components 114, 314, having the aforementioned reduced manufacturing variance of Xₘᵢₙ.

The elastic tubes 102 and the apertures 110, 310 may reside on either of the first, second or third components, respectively, and indeed, some elastic tubes and some apertures may be present on each of these components. Additionally, while cylindrical elastic tubes 102 are particularly useful, the shape may also be non-cylindrical, and may or may not have a varying thickness of the tube wall.

From the foregoing description, several notable aspects of the subject invention will be recognized. For example, some embodiments of the subject invention: 1) eliminate the manufacturing variation associated with the clearances needed for a 2-way and 4-way locating schemes of the prior art; 2) reduce the manufacturing variation by elastically averaging the positional variation; 3) eliminate the float of components as is present in the prior art; 4) provide an over constrained condition that reduces the positional variation by averaging out each locating features variation, and additionally stiffen the joint reducing the number of needed fasteners; 5) provide more precise location of components; and, 6) provide a stiffened assembly of the mated first, second and third components with reduction or elimination of buzz, squeak and rattle (BSR) through elastic deformation with respect to each other, and thereby improve the noise, vibration and harshness (NVH) performance of the assembly of the components.

The elastic tubes 102 may be formed in any suitable manner. They may be integrally formed or manufactured with the first component 106 or they may formed together separately and attached to the first component 106, or they may both be formed entirely separately and attached to the first component 106. When formed separately, they may be formed from different materials than those of the first component 106 to provide a predetermined elastic response characteristic, for example. The material, or materials, may be selected to provide a predetermined elastic response characteristic of any or all of the first component 106 or second component 114 or third component 314. The predetermined elastic response characteristic may include, for example, a predetermined elastic modulus.

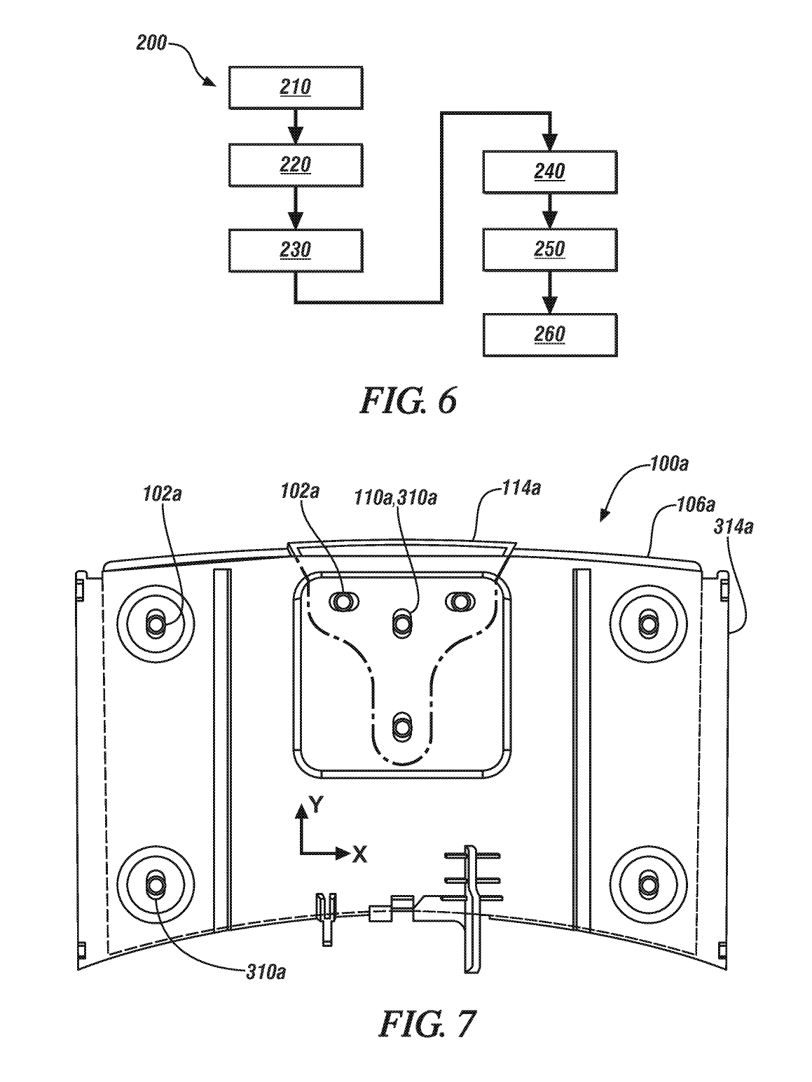

In an embodiment of the invention, and with reference now to FIG. 6, a method 200 for precisely aligning components, and particularly components of a motor vehicle, during a mating operation using the alignment system 100 is disclosed. The method includes providing 210 a first component 106, the first component 106 comprising a plurality of upstanding elastic tubes 102 extending from the first component 106, each elastic tube having a tube wall 102a. The method also includes providing 220 a second component 114 and providing 230 a third component 314, the second component 114 and the third component 314 each having a plurality of respective apertures 110, 310 formed therein, each respective aperture 110, 310 having an aperture wall 116, 316, the plurality of apertures 110, 310 of the second component 114 and the third component 314 geometrically distributed in a coordinated relationship to a geometrical distribution of the plurality of elastic tubes 102 such that each elastic tube 102 is receivable into a respective aperture 110, 310. The method 200 further includes mating 240 the first component 106 to the second component 114, wherein during mating the first component 106 is aligned to the second component 114 and the third component 314 by each elastic tube 102 being received into its respective aperture 110, 310. Still further, the method includes elastically deforming 250 an interface between each elastic tube 102 and its respective aperture 110, 310 in the second component 114 and the third component 314. Finally, the method 200 includes performing 260 an elastic averaging of the elastic deformation over the plurality of elastic tubes 102 such that upon mating, a precise location of the first component 106 to the second 114 and the third 314 components is realized.

From the foregoing, it will be appreciated that the slotted apertures 110, 310, as depicted in FIG. 1, may have their major axes strategically oriented relative to each other so as to provide precise control over the fit of the second and third components 114, 314 relative to the first component 106, where slotted apertures 110 (more specifically 110.1, 110.2, 110.3, 110.4, 110.5, 110.6) are provided in the second component 114, and the slotted apertures 310 (more specifically 310.1, 310.2, 310.3, 310.4, 310.5, 310.6) are provided in the third component 314. For example, and as depicted in FIG. 1, the major axes of slotted apertures 110.1, 310.1, 110.3, 310.3, 110.5, 310.5 are all oriented parallel to the x-axis, and the major axes of slotted apertures 110.2, 310.2, 110.4, 310.4, 110.6, 310.6 are all orient parallel to the y-axis. By strategically orienting the major axes of each slotted aperture, precise alignment of the second and third components 114, 314 relative to the first component 106 in both x and y-directions is achieved, since the width along the minor axis of each slotted aperture interferingly engages in an elastically averaged arrangement with respective ones of the elastic tubes 102.

While FIG. 1 depicts a set of six elastic tubes 102, and two sets of six apertures, 110.1, 110.2, 110.3, 110.4, 110.5, 110.6, and 310.1, 310.2, 310.3, 310.4, 310.5, 310.6, having a certain strategic placement and orientation with respect to each other, it will be appreciated that the scope of the invention is not limited only to the embodiment illustrated in FIG. 1. For example, the scope of the invention also encompasses other numbers of elastic tubes 102 arranged in one-to-one correspondence with pairs of apertures 110, 310, where the major axis of each aperture 110, 310 of a pair of apertures are oriented along a same axis, and where the set of apertures 110, 310 include some pairs of apertures oriented relative to the x-axis and some pairs of apertures oriented relative to the y-axis. An example embodiment alternative to that depicted in FIG. 1 includes eight pairs of apertures 110, 310 arranged in one-to-one correspondence with a respective elastic tube 102, where the major axis of each aperture 110, 310 of a given pair of apertures are oriented along a same axis, where the major axes of two of the eight pairs of apertures 110, 310 are oriented parallel to the x-axis, and where the major axes of six of the eight pairs of apertures 110, 310 are oriented parallel to the y-axis. The aforementioned example embodiment alternative to that depicted in FIG. 1 is only one of many alternative embodiments contemplated and considered to be within the scope of the invention.

For example, and with reference now to FIG. 7, which is a similar view as that depicted in FIG. 1, an embodiment of the invention includes an arrangement of an elastic tube alignment system 100′ that is a tri-layer assembly having first, second and third components 106′, 114′, 314′, respectively, that forms a vehicle interior compartment lid, such as a cup holder lid or a compartment door, for example, or a vehicle exterior trim assembly, such as a front grill, for example, that may or may not include chrome trim or other decorative trim. The entire outline of the third component 314′ is visible in FIG. 7 and is depicted in solid line fashion. Portions of the outline of the second component 114′ are visible in FIG. 7 and are depicted in solid line fashion, with other hidden portions of the outline being depicted in dash-dot line fashion. Portions of the outline of the first component 106′ are visible in FIG. 7 and are depicted in solid line fashion, with other hidden portions of the outline being depicted in dash line fashion. The second component 114′ is sandwiched between the first 106′ and third 314′ components. As depicted in FIG. 7, the four outboard elastic tubes 102a are in elastic averaged engagement with corresponding apertures 310′ of only the third component 314′, while the central four elastic tubes 102a are in elastic averaged engagement with both the corresponding apertures 310′ of the third component 314′ and the corresponding apertures 110′ of the second component 114′. In this manner, a certain combination elastic tubes may be used to align only two components, while another combination of elastic tubes may be used to align three or more components. As such, it will be appreciated that embodiments of the invention include a variety of arrangements where a first subset of elastic tubes of a first component may be engaged with apertures of just a third component, and a second subset of elastic tubes of the first component may be engaged with apertures of both the third component and an intermediary second component. Any and all arrangements consistent with the disclosure herein are contemplated and considered to be within the scope of the invention disclosed herein.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. An elastic tube alignment system for aligning components to one another, comprising:
a first component having a plurality of upstanding elastic tubes, each elastic tube having a tube wall;
a second component;
a third component, wherein the second component is disposed between the first and third components;
a plurality of apertures formed in the second component and the third component, each aperture having an aperture wall, the plurality of apertures geometrically distributed in coordinated relationship to a geometrical distribution of the plurality of elastic tubes such that each elastic tube is receivable into a respective aperture, wherein when each elastic tube is received into its respective aperture an elastic deformation occurs at an interface between the tube wall and the aperture wall, wherein the elastic deformation is responsive to each tube wall having a diameter larger than a cross-section of its respective aperture, and wherein the elastic deformation is elastic averaged over the plurality of elastic tubes such that the first component is precisely located relative to the second component and the third component.

2. The elastic tube alignment system of claim 1, wherein each tube wall defines a hollow cylinder.

3. The elastic tube alignment system of claim 1, wherein the tube wall has a non-cylindrical shape.

4. The elastic tube alignment system of claim 1, wherein the elastic deformation comprises resiliently reversible elastic deformation of each tube wall.

5. The elastic tube alignment system of claim 4, wherein said elastic deformation further comprises resiliently elastic deformation of each said aperture wall.

6. The elastic tube alignment system of claim 4, wherein each tube wall is tapered, the tapered tube wall having a smallest diameter on an end away from the first component.

7. The elastic tube alignment system of claim 6, wherein the respective apertures of the second component have a first aperture width and the apertures of the third component have a third aperture width, the second aperture width and the third aperture width of respective apertures being different.

8. The elastic tube alignment system of claim 7, wherein the second aperture width is larger than the third aperture width.

9. The elastic tube alignment system of claim 1, wherein the apertures of the second component and the third component are elongated apertures.

10. The elastic tube alignment system of claim 9, wherein the elongated apertures of the second component have second elongation axes and the elongated apertures of the third component have third elongation axes, and wherein a predetermined portion of the second elongation axes are parallel to the third elongation axes of respective apertures.

11. The elastic tube alignment system of claim 9, wherein the elongated apertures of the second component have second elongation axes and the elongated apertures of the third component have third elongation axes, and wherein a predetermined portion of the second elongation axes are not parallel to the third elongation axes of respective apertures.

12. The elastic alignment system of claim 1, wherein the second component is disposed proximate the first component and the third component is disposed proximate the second component.

13. The elastic alignment system of claim 1, wherein the respective apertures of the second component have a first aperture width and the apertures of the third component have a third aperture width and the second aperture width is larger than the third aperture width.

14. The elastic alignment system of claim 1, wherein the second component is disposed proximate a first surface of the first component and the third component is disposed proximate a second surface of the first component.

15. The elastic tube alignment system of claim 4, wherein said elastic deformation provides a stiffened assembly of the first, second and third components when these components are mutually mated to each other.

16. A method for precisely aligning components during a mating operation, the method comprising:
providing a first component, the first component comprising a plurality of upstanding elastic tubes extending from the first component, each elastic tube having a tube wall;
providing a second component;
providing a third component, the second component and the third component each having a plurality of apertures formed therein, each aperture having an aperture wall, the plurality of apertures of the second component and the third component geometrically distributed in a coordinated relationship to a geometrical distribution of the plurality of elastic tubes such that each elastic tube is receivable into a respective aperture;
mating the first component to the second component, wherein during mating, the first component is aligned to the second component and the third component by each said elastic tube being received into its respective aperture;
elastically deforming an interface between each elastic tube and its respective aperture in the second component and the third component; and
performing an elastic averaging of the elastic deformation over the plurality of elastic tubes such that upon mating, a precise location of the first component to the second and the third component is realized.

17. The method of claim 16, wherein the elastically deforming comprises resiliently reversible elastic deformation of each elastic tube.

18. The method of claim 17, wherein the mating forms a joint between said first and second components, and wherein the elastic deformation during said step of elastically deforming occurs generally perpendicular to a respectively adjacent local component of the joint.

19. The method of claim 17, wherein during the providing a first component, a second component and a third component, a manufacturing variance of size and position of the elastic tubes and the apertures occurs, wherein the manufacturing variance has an average length of X, and wherein said step of elastic averaging provides a reduced manufacturing variance of length Xₘᵢₙ, where Xₘᵢₙ=X/√N, wherein N is the number of the elastic tubes.
